(19) United States
(12) Patent Application Publication
(10) Pub. No.: US 2014/0000161 A1
(43) Pub. Date: Jan. 2, 2014

(54) INTERLOCKING MODULAR PLANTING SYSTEM FOR ROOF APPLICATIONS

(71) Applicant: David S. MacKenzie, Nunica, MI (US)

(72) Inventor: David S. MacKenzie, Nunica, MI (US)

(21) Appl. No.: 13/538,254

(22) Filed: Jun. 29, 2012

(51) Int. Cl. A01G 9/02; B23P 11/00

(52) U.S. Cl. 47/65.9; 29/428

(57) ABSTRACT

A green-roof planter assembly includes a first planter module and a second planter module each including a bottom wall and a plurality of side walls that cooperate with the bottom wall to form an interior space of the respective planter module, at least a pair of the plurality of sidewalls of each of the modules cooperate to form a corner therebetween having a length extending therealong, and wherein each of the planter modules includes a relief located along a length of the respective corner. The planter assembly further includes a coupler member removably received within the release of each of the planter modules, thereby inhibiting vertical movement of each of the planter modules with respect to one another.

### BACKGROUND OF THE INVENTION

The present invention relates to a modular planting system for roof applications, and in particular to a modular planting system that includes a plurality of planter modules each including a planter for receiving plant matter therein, and a coupling member for securing the plant modules to one another, thereby creating a green-roof system.

### SUMMARY OF THE INVENTION

One aspect of the present invention is to provide a green-roof planter assembly that comprises a first planter module including a bottom wall and a plurality of sidewalls that cooperate with the bottom wall of the first planter module to form an interior space of the first planter module adapted to receive plant matter therein, wherein at least a pair of the plurality of sidewalls of the first planter module cooperate to form a first corner therebetween, the first corner defining a length therealong, and wherein the first planter module includes a first relief located along the length of the first corner. The green-roof planter assembly further includes a second planter module including a bottom wall and a plurality of sidewalls that cooperate with the bottom wall of the second planter module to form an interior space of the second planter module adapted to receive plant matter therein, wherein at least a pair of the plurality of sidewalls of the second planter module cooperate to form a second corner therebetween, the second corner defining a length therealong, and wherein the second planter module includes a second relief located along the length of the second corner. The green-roof planter module still further includes a coupling member removably received within the first relief and the second relief, thereby inhibiting vertical movement of the first planter module with respect to the second planter module.

Another aspect of the present invention is to provide a green-roof planter assembly that comprises a first planter module, a second planter module, a third planter module and a fourth planter module each including a bottom wall, a plurality of sidewalls that cooperate with the bottom wall to form an interior space of the respective planter module adapted to receive plant matter therein, wherein at least a pair of the plurality of sidewalls of each of the planter modules cooperate to form a respective corner therebetween defining a length, and wherein each of the corners includes a relief located along the length of the respective corner, and a coupling member removably received within each of the reliefs of each of the corners, thereby inhibiting vertical movement of the first planter module, the second planter module, the third planter module and the fourth planter module with respect to one another.

Yet another aspect of the present invention is to provide a method of installing a green-roof planter assembly that comprises providing a first planter module including a bottom wall and a plurality of sidewalls that cooperate with the bottom wall of the first planter module to form an interior space of the first planter module adapted to receive plant matter therein, wherein at least a pair of the plurality of sidewalls of the first planter module cooperate to form a first corner therebetween, the first corner defining a length therealong, and wherein the first planter module includes a first relief located along the length of the first corner. The method further comprises providing a second planter module including a bottom wall and a plurality of sidewalls that cooperate with the bottom wall of the second planter module to form an interior space of the second planter module adapted to receive plant matter therein, wherein at least a pair of the plurality of sidewalls of the second planter module cooperate to form a second corner therebetween, the second corner defining a length therealong, and wherein the second planter module includes a second relief located along the length of the second corner. The method further includes positioning the first corner of the first planter module and the second corner of the second planter module proximate one another, providing a coupling member, and inserting the coupling member into the first relief of the first planter module and the second relief of the second planter module, thereby inhibiting vertical movement of the first planter module with respect to the second planter module.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a building employing a green roof system embodying the present invention;

FIG. 2 is a perspective view of a green roof planter module that includes a collar member removably inserted into an associated planter, and a coupling member;

FIG. 3 is an exploded perspective view of the planter module;

FIG. 4 is an enlarged perspective view of the planter module including a cut-away portion of the collar member inserted into the planter;

FIG. 5A is a partial cross-sectional end view of the planter module;

FIG. 5B is a partial cross-sectional end view of an alternative embodiment of the planter module;

FIG. 6 is an end view of the planter;

FIG. 7 is a perspective view of an individual paver assembly;

FIG. 8 is a perspective view of a substrate member of the paver assembly;

FIG. 9 is a partially cross-sectional side view of the substrate member;

FIG. 10 is a perspective view of a shim member utilized for supporting the paver assembly;

FIG. 11 is a perspective view of a coupling member inserted within slots of multiple planter modules; and

FIG. 12 is a top plan view of the coupling member coupling a plurality of adjacent planter modules.

### DETAILED DESCRIPTION OF THE PREFERRED EMBODIMENTS

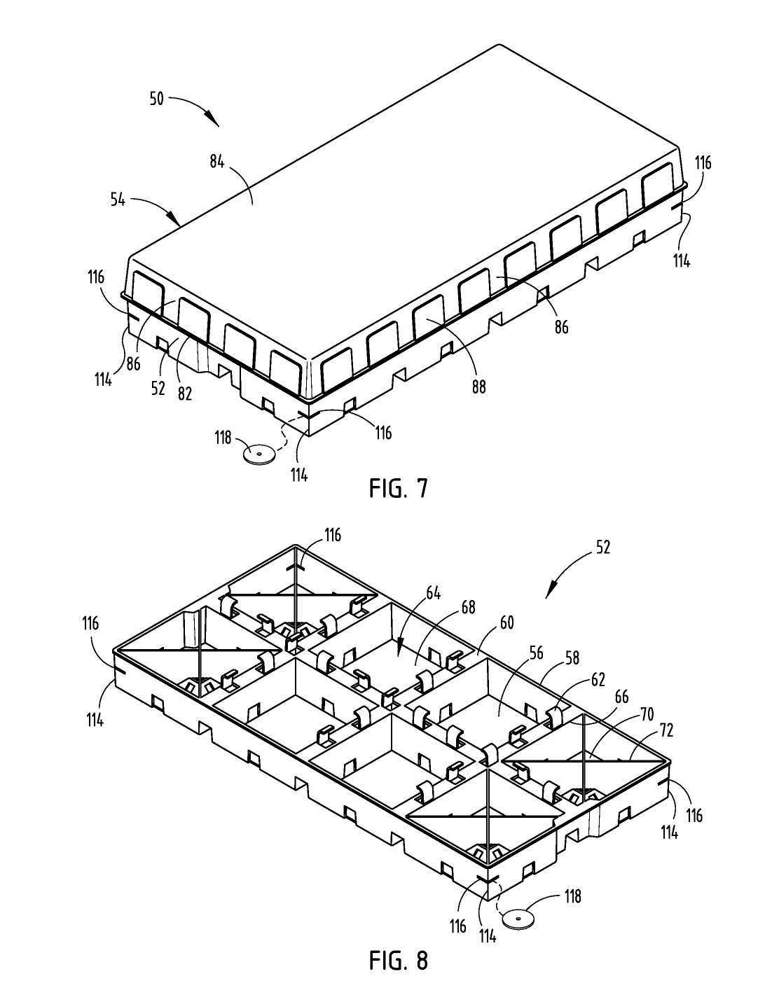

For purposes of description herein, the terms “upper,” “lower,” “right,” “left,” “rear,” “front,” “vertical,” “horizontal,” and derivatives thereof shall relate to the invention as oriented in FIGS. 2 and 7. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

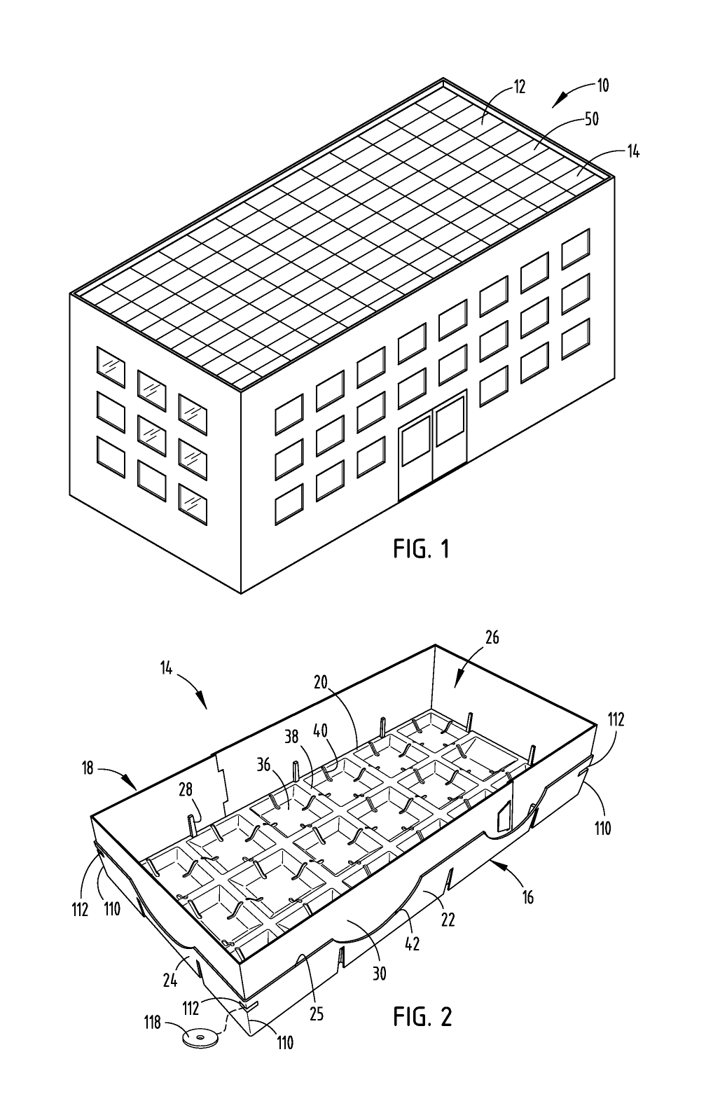

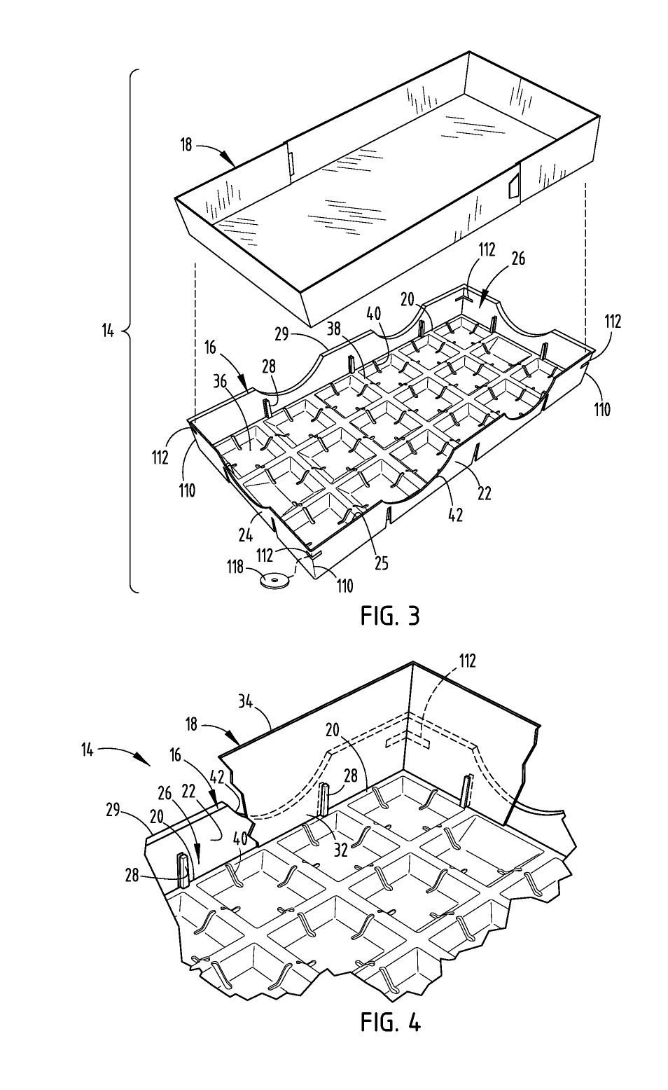

The reference numeral 10 (FIG. 1) generally designates a green roof system embodying the present invention and employed on a building roof 12 and comprising a plurality of individual green roof planter modules 14. In the illustrated example, each of the planter modules 14 (FIGS. 2 and 3) comprises a planter 16 and a removable collar 18 inserted into the planter 16 such that the collar 18 extends upwardly from an uppermost edge of the planter 16, thereby allowing the retention of plant matter that extends above an upper edge of the planter 16.

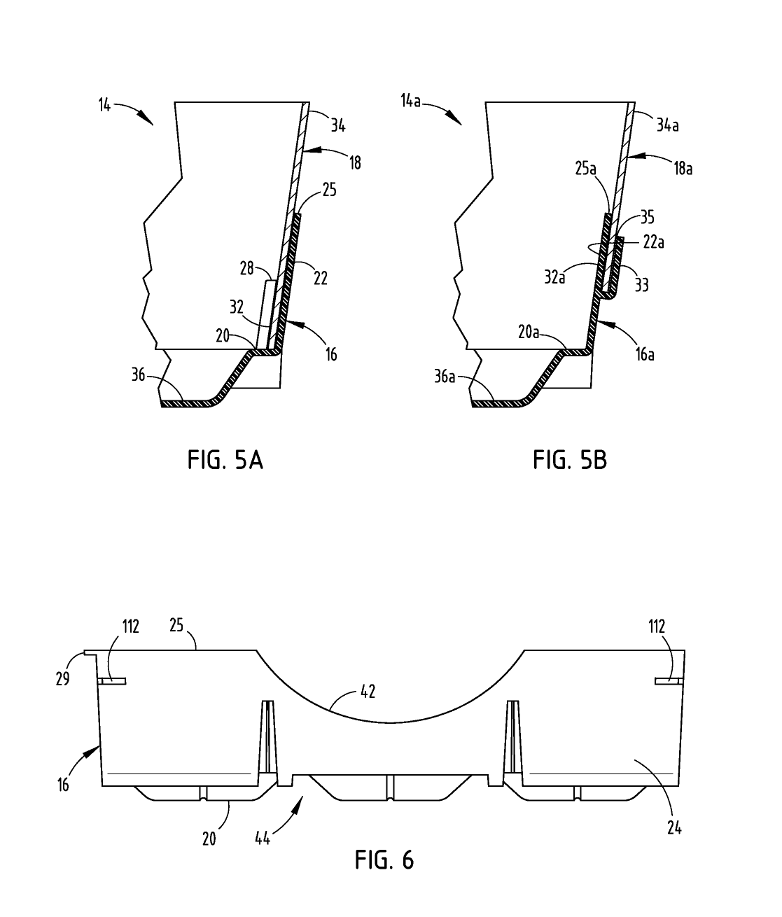

Each planter 16 includes a bottom wall 20, a plurality of walls that include sidewalls 22 and end walls 24 that cooperate with the bottom wall 20 to form an interior space 26, and a plurality of support tabs 28 (FIGS. 4 and 5a) spaced about the interior space 26 and that extend inwardly toward the interior space 26. Each of the sidewalls 22 and end walls 24 include a top edge 25. As best illustrated in FIG. 4, each of the support tabs 28 extends upwardly from the bottom wall 20 and is spaced from an associated sidewall 22 or end wall 24. The planter 16 is preferably integrally molded by press forming, and the like, and is constructed of a material such as plastic. In the illustrated example, the planter 16 is providing a rectangularly-shaped overall plan form, however, other configurations may also be utilized. Further, it is noted that the tabs 28 are configured to abut the bottom surface of the bottom wall 20 of another planter 16 when multiple planters are placed in a stacked relationship. As illustrated, one of the sidewalls 22 and one of the end walls 24 each include an outwardly-extending overlap tab 29 that overlaps a respective sidewall or end wall of an adjacent planter 16.

The collar member 18 includes a plurality of walls 30 each having a bottom edge 32 and a top edge 34. In the illustrated example, the collar member 18 comprises two pieces that extend in a rectangular manner about the planter 16. Specifically, the collar member 18 extends about the interior space 26 of the associated planter 16 such that the bottom edge 32 of each of the walls 30 is inserted between the sidewalls and end walls 22, 24 of the planter 16 and the associated support tabs 28, thereby retaining the collar member 18 within the interior space 26 of the planter 16, and such that the walls 30 of the collar member 18 extend upwardly from the top edge 25 of the sidewalls and end walls 22, 24 of the planter 16. Although locking tabs are illustrated between each of the pieces of the collar, overlapping, non-tabbed ends may also be utilized.

In operation, the collar member 18 is inserted into the interior space 26 of planter 16, in a manner described above, and a plant matter that comprises grown plants, plant seedlings, plant seeds and the like, and soil and/or aggregate is also inserted into the interior space 26 of the planter 16. Subsequently, plants are grown within the interior space 26 until such plant matter extends upwardly above the top edge 25 of the sidewalls and end walls 22, 24 of the planter 16. The planter module 14 is then placed in rows or a grid work-like pattern upon a roof 12 (FIG. 1) and the collar member 18 removed such that the plant matter within the interior space 26 of the planter 16 abuts similar plant matter in adjacent planter modules 14, thereby providing a connected roof system that will quickly provide an interconnected and aesthetically-pleasing planted surface. Alternatively, the collar member 18 comprises a biodegradable material that may be left within the planter 16 placed within the overall grid work of the green roof system 10. It is also noted that the walls 30 of the collar member 18 angles outwardly from the sidewalls and end walls 22, 24 of the planter 16, thereby promoting a tight abutment of the plant matter extending above the top edge 25 of the sidewalls and end walls 22, 24 between adjacent planter modules 14.

The proper communication of water between adjacent planters 16 is provided by various elements within the planter 16. As best illustrated in FIG. 2, the bottom wall 20 of the planter 16 comprises a grid work-like pattern of recesses 36 segmented by raised portions 38. A plurality of drainage apertures 40 extend through the recesses 36 and the raised portions 38. It is noted that at least a portion of each of the drainage apertures 40 extend through a lowermost portion of the bottom wall 20, thereby eliminating standing water within the planter 16. Each of the sidewalls and end walls 22, 24 of the planter 16 also include arcuately-shaped recesses or apertures 42 extending therethrough that align with similar apertures of adjacent planters when positioned within the overall gridwork. As illustrated, each of the apertures extends downwardly from the top edge 25 of the sidewalls and end walls 22, 24, a distance that is greater than half of the distance between the top edge 25 and a point at which the bottom wall 20 intersects the sidewalls and/or end wall 22, 24, thereby providing adequate water communication between adjacent planters 16 and further allowing for the migration of plant matter therebetween.

The reference numeral 14a (FIG. 5B) generally designates another embodiment of the present inventive planter module. Since the planter module 14a is similar to the previously-described planter module 14, similar parts appearing in FIGS. 2-5a and FIG. 5b, respectively are represented by the same, corresponding reference numeral, except for the suffix “a” in the numerals of the latter. In the planter module 14a, the top edge 25a of each of the sidewalls 22a and end walls 24a include an upwardly-opening channel 33 defining a pocket 35 within which the bottom edge 32a of the collar member 18a is inserted.

The planter 16 (FIG. 6) further includes a pair of gripping reliefs 44 located at each end thereof. Specifically, each relief 44 is provided within the intersection of an associated end wall 24 and the bottom wall 20 such that a user is able to insert their fingers into the reliefs 44, thereby allowing easy gripping and support of the planter module 14.

The reference numeral 50 (FIG. 7) generally designates a paver assembly. In the illustrated example, a plurality of the paver assemblies 50 are used in conjunction with a plurality of modular planting assemblies 14 utilized to provide a vegetated roof system upon the building roof 12. The plurality of paver assemblies 50 cooperate to provide a support structure upon which persons can move about the vegetated roof system in order to maintain the same, enjoy the park-like setting as created by the system, and the like.

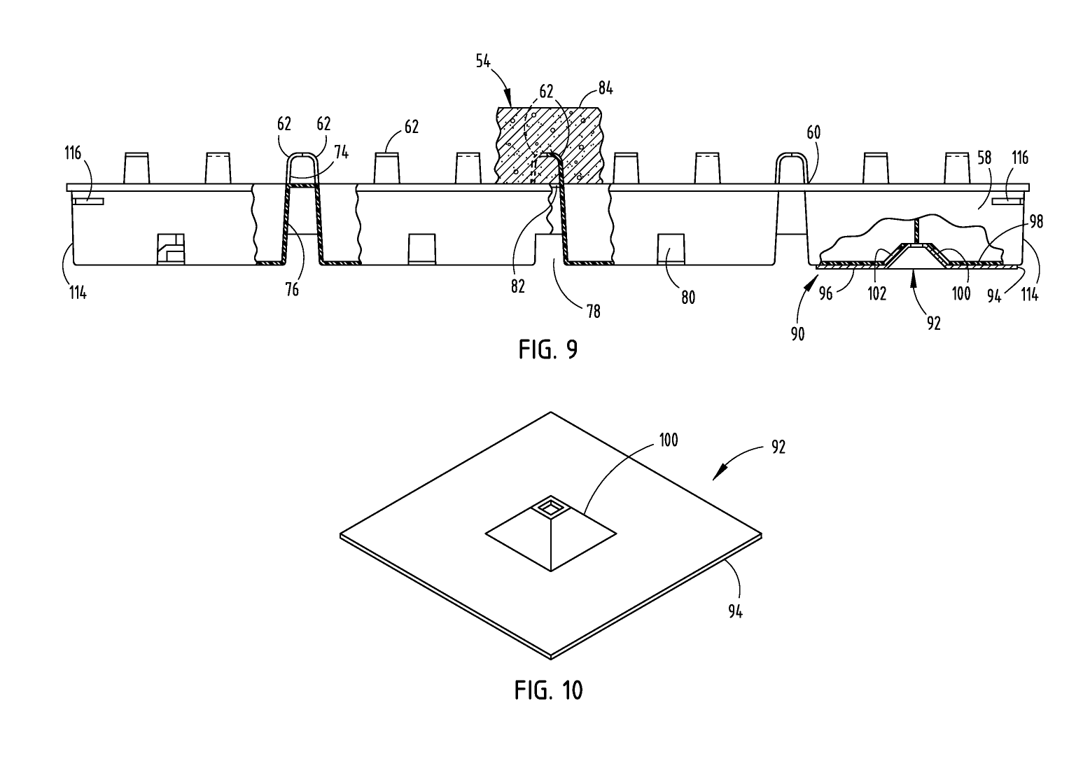

As best illustrated in FIG. 7, each paver assembly 50 comprises a substrate member 52 and an over-molded paver member 54. The substrate member 52 is preferably constructed of a recycled polypropylene material, however, other materials compatible for such use may be utilized. The substrate member 52 (FIG. 8) includes a box-like structure having a bottom wall 56 adapted to support the paver assembly 50 above the roof surface, a plurality of sidewalls 58 extending upwardly from the bottom wall 56, a top wall 60, and a plurality of engagement members 62 extending upwardly from the top wall 60. The bottom wall 56 and the sidewalls 58 cooperate to form an interior space 64 that is subdivided into multiple compartments via a plurality of intermediate walls 66 extending between pairings of sidewalls 58. In the illustrated example, the interior space 64 is divided into eight compartments including central compartments 68 and end compartments 70. Each end compartment 70 is subdivided by crosswise-extending structural reinforcement walls 72 that serve to structurally reinforce the outwardly lying end portions of the substrate member 52 and overall paver assembly 50, as described below. As best illustrated in FIG. 9, each engagement member 62 is hook-shaped, and includes an outer surface 74 that is aligned with an outer surface 76 of a corresponding intermediate wall 66, thereby serving to structurally reinforce the engagement member 62 as the engagement member 62 is positioned directly above and extends upwardly from the intermediate wall 66.

A plurality of water passages 78 extend beneath the substrate member 52 and are formed by cooperating pairs of intermediate walls 66, thereby allowing water to pass beneath the paver assembly 50. In addition, a plurality of apertures 80 extend through the intermediate walls 66 and the sidewalls 58, thereby providing fluid communication between the interior space 64 of the substrate member 52 and allowing water to pass from the interior space 64 to the water passages 78 and/or the exterior of the substrate member 52.

The paver member 54 includes a bottom surface 82, a top surface 84, and a plurality of side surfaces 86 extending therebetween. The top surface 84 is adapted to support a person thereon. The paver member 54 is preferably constructed from a light-weight concrete, or other suitable material that may be formed about the engagement members 62 of the substrate member 52, as described below.

As best illustrated in FIG. 7, the paver member 54 is formed to include a plurality of irregularities in the form of rectangularly-shaped tabs 88 extending outwardly from the side surfaces 84. In use, the tabs 88 abut the tabs 88 of adjacently-positioned paver assemblies 50, and cooperate to form gaps or spaces between abutting paver assemblies, thereby allowing water to flow therebetween.

In order to compensate for unlevel roof structures, a shim system 90 (FIG. 9) is provided. Each shim 92 (FIG. 10) is provided a square-shape body portion 94 having a bottom surface 96 adapted to abut the roof structure, and a top surface 98 adapted to abut a portion of the bottom wall 56 of the substrate member 52. A trapezoidally-shaped engagement member 100 extends upwardly from the body portion 94 and is received into a corresponding trapezoidally-shaped recess 102 extending into the bottom wall 56 of the substrate member 52. The corresponding trapezoidal-shape of both the engagement member 100 and the recess 102 cooperate to properly orient the shim member 92 with respect to the paver assembly 50, and also prevents the shim member 92 from shifting with respect to the paver assembly 50 subsequent to assembly. The shim member 92 is preferably constructed of a recycled polypropylene material, however, other material suitable for such use may be utilized.

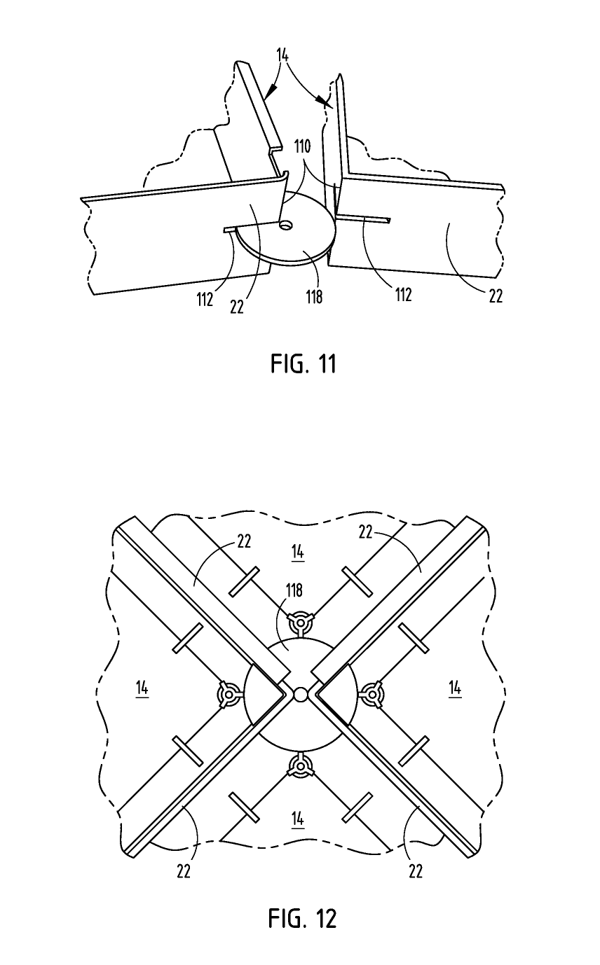

Each corner 110 (FIGS. 2-4 and 6) of each of the planters 16 located between adjacent sidewalls 22 are provided with slots 112 extending horizontally and longitudinally along the sidewalls 22, while each corner 114 (FIGS. 7-9) of each of the substrate members 54 are provided with slots 116 extending horizontally and longitudinally along the sidewalls 58, wherein the slots 112 and the slots 116 receive a coupling member 118 therein, thereby preventing any single planter module 14 and/or paver assembly 50 from being displaced a vertical direction without necessarily also vertically displacing adjacent planter modules 14 and/or paver assemblies 50. As best illustrated in FIGS. 11 and 12, each coupling member 118 is disk-shaped being substantially planar and having a circular plan form. The interlocking arrangement as provided by the coupling members 118 prevent single or multiple planter modules 14 and/or paver assemblies from being dislodged and displaced from the associated roof surface during inclement conditions such as high winds.

The present inventive green roof system provides coverage of an entire roof area quickly and economically by allowing the associated modules to be grown off-sight in a manner that allows the plant matter to extend upwardly from an associated planter and plant matter within adjacent modules to abut immediately upon installation. The roof system is also easy to install at a relatively low cost. Further, the system provides improved water communication and drainage between adjacent modules, allows easy maintenance of the overall system, can be installed easily and quickly by even unskilled personnel, is capable of a long-operating life, and is particularly well adapted for the proposed use. Moreover, the present inventive interlocking arrangement between adjacent modules/assemblies prevents any single module/assembly from being vertically displaced without necessarily vertically displacing adjacent modules/assemblies.

In the foregoing description, it will be readily appreciated by those skilled in the art, that modifications may be made to the invention without departing from the concepts as disclosed herein, such modifications are to be considered as included in the following claims, unless these claims by their language expressly state otherwise.

1. A green roof planter assembly, comprising:
a first planter module including a bottom wall and a plurality of side walls that cooperate with the bottom wall of the first planter module to form an interior space of the first planter module adapted to receive plant matter therein, wherein at least a pair of the plurality of side walls of the first planter module cooperate to form a first corner therebetween, the first corner defines a length therealong, and wherein first planter module includes a first relief located along the length of the first corner;
a second planter module including a bottom wall and a plurality of side walls that cooperate with the bottom wall of the second planter module to form an interior space of the second planter module adapted to receive plant matter therein, wherein at least a pair of the plurality of side walls of the second planter module cooperate to form a second corner therebetween, the second corner defines a length therealong, and wherein the second planter module includes a second relief located along the length of the second corner; and
a coupling member removably received within the first relief and the second relief, thereby inhibiting vertical movement of the first planter module with respect to the second planter module.

2. The green roof planter assembly of claim 1, further comprising:
a third planter including a bottom wall and a plurality of side walls that cooperate with the bottom wall of the third planter module to form an interior space of the third planter module adapted to receive plant matter therein, wherein at least a pair of the plurality of side walls of the third planter module cooperate to form a third corner therebetween, the third corner defines a length therealong, the third planter module includes a third relief located along the length of the third corner, and wherein the coupling member is removably received within the third relief, thereby inhibiting vertical movement of the third planter module with respect to the first and second planter modules.

3. The green roof planter assembly of claim 1, wherein the first relief comprises a slot extending longitudinally along a length of at least one of the plurality of side walls of the first planter module.

4. The green roof planter assembly of claim 1, wherein the slot extends longitudinally along a length of each of a pair of side walls of the plurality of side walls of the first planter module.

5. The green roof planter assembly 1, wherein the first relieve comprises a horizontal slot extending longitudinally along a length of at least one of the plurality of side walls of the first planter module.

6. The green roof planter assembly of claim 1, wherein the coupling member is a single, integral piece.

7. The green roof planter assembly of claim 1, wherein the coupling member comprises a planar member having a circular cross-section configuration.

8. The green roof planter assembly of claim 1, wherein the first planter module further includes a removable collar member extending upwardly from at least a select one of the plurality of sidewalls of the first planter module, and wherein the collar member is adapted to retain a plant matter that extends above the plurality of sidewalls of the first planter module.

9. The green roof planter assembly of claim 8, wherein the collar member is supported within the interior space of the first planter module by at least one support tab
that extends inward towards the interior space of the first planter module from at least a select one of the bottom wall of the first planter module and the plurality of side walls of the first planter module.

10. A green roof planter assembly, comprising:
a first planter module including a bottom wall and a plurality of side walls that cooperate with the bottom wall of the first planter module to form an interior space of the first planter module adapted to receive plant matter therein, wherein at least a pair of the plurality of side walls of the first planter module cooperate to form a first corner therebetween, the first corner defines a length therealong, and wherein first planter module includes a first relief located along the length of the first corner;
a second planter module including a bottom wall and a plurality of side walls that cooperate with the bottom wall of the second planter module to form an interior space of the second planter module adapted to receive plant matter therein, wherein at least a pair of the plurality of side walls of the second planter module cooperate to form a second corner therebetween, the second corner defines a length therealong, and wherein the second planter module includes a second relief located along the length of the second corner;
a first planter module including a bottom wall and a plurality of side walls that cooperate with the bottom wall of the first planter module to form an interior space of the first planter module adapted to receive plant matter therein, wherein at least a pair of the plurality of side walls of the first planter module cooperate to form a first corner therebetween, the first corner defines a length therealong, and wherein first planter module includes a first relief located along the length of the first corner;
a third planter module including a bottom wall and a plurality of side walls that cooperate with the bottom wall of the third planter module to form an interior space of the third planter module adapted to receive plant matter therein, wherein at least a pair of the plurality of side walls of the third planter module cooperate to form a third corner therebetween, the third corner defines a length therealong, and wherein the third planter module includes a third relief located along the length of the third corner;
a fourth planter module including a bottom wall and a plurality of side walls that cooperate with the bottom wall of the fourth planter module to form an interior space of the fourth planter module adapted to receive plant matter therein, wherein at least a pair of the plurality of side walls of the fourth planter module cooperate to form a fourth corner therebetween, the fourth corner defines a length therealong, and wherein the fourth planter module includes a fourth relief located along the length of the fourth corner; and
a coupling member removably received within the first relief, the second relief, the third relief and the fourth relief, thereby inhibiting vertical movement of the first planter module, the second planter module, the third planter module and the fourth planter modules with respect to one another.

11. The green roof planter assembly of claim 10, wherein the first relief comprises a slot extending longitudinally along a length of at least one of the plurality of side walls of the first planter module.

12. The green roof planter assembly of claim 10, wherein the slot extends longitudinally along a length of each of a pair of side walls of the plurality of side walls of the first planter module.

13. The green roof planter assembly 10, wherein the first relieve comprises a horizontal slot extending longitudinally along a length of at least one of the plurality of side walls of the first planter module.

14. The green roof planter assembly of claim 10, wherein the coupling member is a single, integral piece.

15. The green roof planter assembly of claim 10, wherein the coupling member comprises a planar member having a circular cross-section configuration.

16. The green roof planter assembly of claim 10, wherein the first planter module further includes a removable collar member extending upwardly from at least a select one of the plurality of sidewalls of the first planter module, and wherein the collar member is adapted to retain a plant matter that extends above the plurality of sidewalls of the first planter module.

17. The green roof planter assembly of claim 16, wherein the collar member is supported within the interior space of the first planter module by at least one support tab that extends inward towards the interior space of the first planter module from at least a select one of the bottom wall of the first planter module and the plurality of side walls of the first planter module.

18. A method of installing a green roof planter assembly comprising the steps of:
providing a first planter module including a bottom wall and a plurality of side walls that cooperate with the bottom wall of the first planter module to form an interior space of the first planter module adapted to receive plant matter therein, wherein at least a pair of the plurality of side walls of the first planter module cooperate to form a first corner therebetween, the first corner defines a length therealong, and wherein first planter module includes a first relief located along the length of the first corner;
providing a second planter module including a bottom wall and a plurality of side walls that cooperate with the bottom wall of the second planter module to form an interior space of the second planter module adapted to receive plant matter therein, wherein at least a pair of the plurality of side walls of the second planter module cooperate to form a second corner therebetween, the second corner defines a length therealong, and wherein the second planter module includes a second relief located along the length of the second corner;
positioning the first corner of the first planter module and the second corner of the second planter module proximate one another;
providing a coupling member; and
inserting the coupling member into the first relief of the first planter module and the second relief of the second planter module, thereby inhibiting vertical movement of the first planter module with respect to the second planter module.

19. The method of claim 18, further comprising:
providing a third planter module including a bottom wall and a plurality of side walls that cooperate with the bottom wall of the third planter module to form an interior space of the third planter module adapted to receive plant matter therein, wherein at least a pair of the plurality of side walls of the third planter module cooperate to form a third corner therebetween, the third corner defines a length therealong, and wherein the third planter module includes a third relief located along the length of the third corner;
providing a fourth planter module including a bottom wall and a plurality of side walls that cooperate with the bottom wall of the fourth planter module to form an interior space of the fourth planter module adapted to receive plant matter therein, wherein at least a pair of the plurality of side walls of the fourth planter module cooperate to form a fourth corner therebetween, the fourth corner defines a length therealong, and wherein the fourth planter module includes a fourth relief located along the length of the fourth corner;
wherein the position step further includes positioning the third corner of the third planter module and the fourth corner of the fourth planter module proximate the first corner of the first planter module and the second corner of the second planter module; and
wherein the inserting step further includes inserting the coupling member into the third relief of the third planter module and the fourth relief of the fourth planter module, thereby inhibiting vertical movement of the first planter module, the second planter module, the third planter module and the fourth planter module with respect to one another.

20. The method of claim 18, further comprising:
providing a removable collar member extending upwardly from at least a select one of the plurality of sidewalls of the first planter module, and wherein the collar member is adapted to retain a plant matter that extends above the plurality of sidewalls of the first planter module.
